(19) United States
(12) Patent Application Publication
(10) Pub. No.: US 2026/0202576 A1
(43) Pub. Date: Jul. 16, 2026

(54) METHOD AND SYSTEM FOR TRACKING GROUT DIFFUSION BY INTEGRATING OPTICAL FIBER SENSING AND ELECTRICAL RESISTANCE TOMOGRAPHY

(71) Applicant: SHANDONG UNIVERSITY, Jinan (CN)

(72) Inventors: Zhenhao XU, Jinan (CN); Yihui LI, Jinan (CN); Shengzhe ZHAO, Jinan (CN); Andong HU, Jinan (CN); Dongdong PAN, Jinan (CN); Zehua BU, Jinan (CN); Yang LIU, Jinan (CN)

(21) Appl. No.: 19/435,909

(22) Filed: Dec. 30, 2025

(30) Foreign Application Priority Data
Jan. 14, 2025 (CN) 2025100581968

(51) Int. Cl. G01V 11/00; G01V 3/20; G01V 3/38; G01V 8/16

(52) U.S. Cl. CPC G01V 11/002; G01V 3/20; G01V 3/38; G01V 8/16

(57) ABSTRACT

A method for tracking grout diffusion by integrating optical fiber sensing and electrical resistance tomography, including: conducting geological exploration on area to be grouted; identifying area with highly complex geological conditions based on geological exploration result of area to be grouted; acquiring electrical resistivity data in real time through electrode network uniformly arranged across entire surface of tunnel face, and acquiring global electrical resistivity change data in grouting process using electrical resistance tomography; acquiring optical fiber sensing data in real time using optical fiber sensing arranged in grouting borehole to further acquire local strain, temperature and pressure data; performing data fusion and calculation analysis based on global electrical resistivity change data and local strain, temperature and pressure data; and determining grout front position and grout diffusion boundary in resistivity imaging based on data fusion and calculation analysis result to further determine grout diffusion range and capture grout diffusion process.

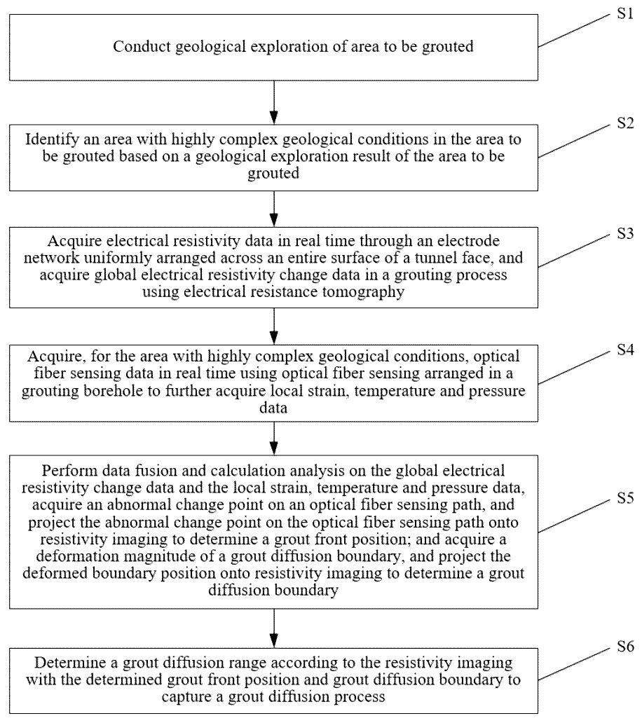

### CROSS-REFERENCE TO RELATED APPLICATIONS

The present invention claims priority benefits to Chinese Patent Application No. 202510058196.8, entitled “Method and System For Tracking Grout Diffusion By Integrating Optical Fiber Sensing and Electrical Resistance Tomography”, filed on Jan. 14, 2025, with the China National Intellectual Property Administration, which is incorporated herein by reference in its entirety and constitutes a part of the present invention for all purposes.

### TECHNICAL FIELD

The present invention relates to the technical field of geotechnical engineering, and in particular to a method and system for tracking grout diffusion by integrating optical fiber sensing and electrical resistance tomography.

### BACKGROUND

In recent years, significant progress has been made in the field of tunnel transportation, especially in the development of transportation hubs, mountain railways and urban subsurface spaces. Tunnel construction has become an important technique to improve the transportation capacity and promote the regional economic development. Common geological disasters in tunnel construction include water inrush, mud inrush, collapse and rockburst, which occur frequently in areas with weak surrounding rock, high ground stress, and water-rich formations. Water and mud inrushes are caused by excessive groundwater pressure or insufficient strength of surrounding rock. Collapse is generally caused by poor stability of surrounding rock or improper support. Rockburst is caused by stress release from rocks with high ground stress. Effective geological exploration, grouting reinforcement and construction adjustment are keys to preventing these disasters.

The main function of the grouting technology is to inject grout materials into the formation to fill fissures or voids therein, so as to reinforce the formation, reduce permeability and control deformation. The grouting technology can enhance the load-bearing capacity of the surrounding rock, and effectively control the seepage of groundwater, making it an important technique in tunnel construction and formation reinforcement projects. Efficient grouting construction requires real-time monitoring of the grout diffusion state to ensure the uniform and sufficient filling of a target area with the grout and to avoid engineering quality problems caused by insufficient or excessive grouting.

However, there are many defects in the existing grouting monitoring technology. For example, conventional monitoring methods mainly rely on sensors arranged on the ground surface or in boreholes, and these sensors are difficult to comprehensively reflect the diffusion behavior of grout under complex geological conditions. In addition, conventional methods have low space resolution and sensitivity, making it difficult to accurately acquire real-time dynamic information of the grout diffusion. Particularly in deep complex formations, the monitoring precision and reliability are greatly restricted. Therefore, how to effectively track the diffusion path and concentration distribution of grout has become an urgent problem to be solved in the engineering field.

The optical fiber sensing technology has received extensive attention in the application of grout diffusion monitoring due to its advantages of high sensitivity, resistance to electromagnetic interference and the long-distance distributed monitoring capability. The optical fiber sensing tracks the grout diffusion path by monitoring the temperature or strain change. However, by singly relying on the optical fiber sensing technology, it is often difficult to precisely acquire specific information on grout concentration distribution and imaging data on spatial diffusion morphology in complex geological environments. In addition, in complex formations with strong interference sources, the measurement precision may be affected to a certain degree.

Therefore, the stability and accuracy of the existing grout diffusion tracking technology are insufficient.

### SUMMARY

In order to solve the above problems, the present invention provides a method and system for tracking grout diffusion by integrating optical fiber sensing and electrical resistance tomography. Based on the acquisition of global electrical resistivity, local strain, temperature and pressure data in the grout diffusion process is monitored using optical fiber sensing to realize refined global and local tracking on the grout.

According to some embodiments, the present invention adopts the following technical solutions.

A method for tracking grout diffusion by integrating optical fiber sensing and electrical resistance tomography, including:
conducting geological exploration of an area to be grouted;
identifying an area with highly complex geological conditions in the area to be grouted
based on a geological exploration result of the area to be grouted;
acquiring electrical resistivity data in real time through an electrode network uniformly arranged across an entire surface of a tunnel face, and acquiring global electrical resistivity change data in a grouting process using electrical resistance tomography;
acquiring, for the area with highly complex geological conditions, optical fiber sensing data in real time using optical fiber sensing arranged in a grouting borehole to further acquire local strain, temperature and pressure data;
performing data fusion and calculation analysis on the acquired global electrical resistivity change data and the local strain, temperature and pressure data, acquiring a change rate of data through calculation, defining a point as an abnormal change point when the change rate exceeds a predefined critical value, extracting the abnormal change point, and projecting the abnormal change point on an optical fiber sensing path onto resistivity imaging to determine a grout front position; acquiring a deformation magnitude of a grout diffusion boundary through calculation, and projecting the deformed boundary position onto resistivity imaging to determine a grout diffusion boundary; and
determining a grout diffusion range according to the resistivity imaging with the determined grout front position and grout diffusion boundary to capture a grout diffusion process.

According to some embodiments, the present invention adopts the following technical solutions.

A system for tracking grout diffusion by integrating optical fiber sensing and electrical resistance tomography, including: an area module, a resistance module, an optical fiber module and a grout diffusion range analysis module; wherein,
the area module is configured to identify an area with highly complex geological conditions in the area to be grouted based on a geological exploration result of the area to be grouted;
the resistance module is configured to acquire electrical resistivity data in real time through an electrode network uniformly arranged across an entire surface of a tunnel face, and acquire global electrical resistivity change data in a grouting process using electrical resistance tomography;
the optical fiber module is configured to acquire optical fiber sensing data of the area with highly complex geological conditions in real time using optical fiber sensing arranged in a grouting borehole to further acquire local strain, temperature and pressure data;
the grout diffusion range analysis module is configured to perform data fusion and calculation analysis on the global electrical resistivity change data and the local strain, temperature and pressure data, acquire a change rate of data through calculation, define a point as an abnormal change point when the change rate exceeds a predefined critical value, extract the abnormal change point, and project the abnormal change point on an optical fiber sensing path onto resistivity imaging to determine a grout front position; and acquire a deformation magnitude of a grout diffusion boundary through calculation, and project the deformed boundary position onto resistivity imaging to determine a grout diffusion boundary; and
a grout diffusion range is determined according to the resistivity imaging with the determined grout front position and grout diffusion boundary to capture a grout diffusion process.

According to some embodiments, the present invention adopts the following technical solutions.

A computer program product, including a computer program; wherein, when the computer program is executed by a processor, causing the processor to implement the method for tracking grout diffusion by integrating optical fiber sensing and electrical resistance tomography.

According to some embodiments, the present invention adopts the following technical solutions.

A non-transitory computer-readable storage medium, configured to store a computer instruction; wherein, when the computer instruction is executed by a processor, causing the processor to implement the method for tracking grout diffusion by integrating optical fiber sensing and electrical resistance tomography.

According to some embodiments, the present invention adopts the following technical solutions.

An electronic device, including a processor, a memory and a computer program; wherein the processor is connected to the memory, and the computer program is stored in the memory, and when the electronic device operates, the processor executes the computer program stored in the memory, so as to cause the electronic device to implement the method for tracking grout diffusion by integrating optical fiber sensing and electrical resistance tomography.

Compared with the prior art, the present invention has the following beneficial effects:

According to the method for tracking grout diffusion by integrating optical fiber sensing and electrical resistance tomography of the present invention, an ERT (Electrical Resistance Tomography) electrode is arranged on the surface of a tunnel face to globally capture the electrical resistivity change data, optical fiber is arranged in a borehole in a local area with complex formation conditions to monitor the local strain, temperature and pressure data in the grout diffusion process, and refined global and local tracking on the grout is finally realized through the data fusion analysis on the global electrical resistivity change data and the local strain, temperature and pressure data.

Based on data fusion analysis, two approaches are provided. One is diffusion range prediction based on feature extraction and fusion, which uses intelligent methods such as machine learning models and deep learning models for feature extraction and fusion, and introduces constraint conditions based on a physical law to constrain the model training so as to improve the accuracy and real-time performance. The other is diffusion range construction based on data analysis, which first determine an approximate diffusion range based on the preprocessed global electrical resistivity change data, then determine a precise grout front position and grout diffusion boundary based on the preprocessed local strain, temperature and pressure data, accumulate the further acquired diffusion path over time, and refine the approximate diffusion range.

### BRIEF DESCRIPTION OF THE DRAWINGS

The accompanying drawings constituting a part of the present invention are used to provide a further understanding of the present invention. The exemplary embodiments of the present invention and descriptions thereof are used to explain the present invention, and do not constitute an improper limitation to the present invention.

The FIGURE is a flowchart of a method in examples of the present invention.

### DETAILED DESCRIPTION

The present invention will be further illustrated hereafter in combination with accompanying drawings and embodiments.

It should be noted that, the following detailed descriptions are exemplary, and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

### Explanation of Terms

Diffusion path is a dynamic grouting route. Diffusion range is a grout diffusion area within a specific time period, and represents the final grouting outcome.

### Example 1

A method for tracking grout diffusion by integrating optical fiber sensing and electrical resistance tomography is provided in the present example of the present invention, including:
geological exploration of an area to be grouted is conducted;
an area with highly complex geological conditions in the area to be grouted is identified based on a geological exploration result of the area to be grouted;
electrical resistivity data is acquired in real time through an electrode network uniformly arranged across an entire surface of a tunnel face, and global electrical resistivity change data in a grouting process is acquired using electrical resistance tomography;
for the area with highly complex geological conditions, optical fiber sensing data is acquired in real time using optical fiber sensing arranged in a grouting borehole to further acquire local strain, temperature and pressure data;
the acquired global electrical resistivity change data and local strain, temperature and pressure data are subjected to data fusion and calculation analysis,
a change rate of data is acquired through calculation, a point is defined as an abnormal change point when the change rate exceeds a predefined critical value, the abnormal change point is extracted, and the abnormal change point on an optical fiber sensing path is projected onto resistivity imaging to determine a grout front position; a deformation magnitude of a grout diffusion boundary is acquired through calculation, and the deformed boundary position is projected onto resistivity imaging to determine a grout diffusion boundary; and
a grout diffusion range is determined according to the resistivity imaging with the determined grout front position and grout diffusion boundary to capture a grout diffusion process.

As an embodiment, according to the method for tracking grout diffusion by integrating optical fiber sensing and electrical resistance tomography of the present invention, based on the acquisition of global electrical resistivity, local strain, temperature and pressure data in the grout diffusion process is monitored using optical fiber sensing to realize refined global and local tracking on the grout. As shown in the FIGURE, a specific implementation process is as follows:

Step S1: geological exploration of an area to be grouted is conducted.

Step S2: an area with highly complex geological conditions in the area to be grouted is identified based on a geological exploration result of the area to be grouted.

Further, the area with highly complex geological conditions is obtained by labeling formation complexity according to subsurface structure and formation feature data obtained in the geological exploring result to divide areas with different geological conditions into areas with highly complex geological conditions and areas with lowly complex geological conditions.

Specifically, the preliminary geological exploration and the complex area identification are performed, subsurface structure and formation feature data is acquired according to the preliminary geological exploration result, an area with a complex formation is labeled, and areas with different geological conditions are divided into areas with highly complex geological conditions and areas with lowly complex geological conditions. The area with highly complex geological conditions includes but is not limited to: a fissure zone, a fracture zone, a water-rich formation, a tight formation, a weak formation, and a heterogeneous rock formation. The basis is provided for the arrangement of optical fibers and electrodes of electrical resistance tomography equipment.

Step S3: electrical resistivity data is acquired in real time through an electrode network uniformly arranged across an entire surface of a tunnel face, and global electrical resistivity change data in a grouting process is acquired using electrical resistance tomography.

Further, according to the electrical resistance tomography, a Gauss-Newton inversion algorithm is adopted to derive electrical resistivity distribution of a subsurface formation based on the electrical resistivity data, an electrical resistivity distribution map at each time point is acquired through a continuous inversion process, and the global electrical resistivity change data in the grouting process is further acquired.

Specifically, the electrode network is uniformly arranged across the entire surface of the tunnel face, and the electrode arrangement range and density may cover the estimated grout diffusion range.

The electrical resistivity data at an initial stage is acquired before grouting, and an initial electrical resistivity distribution map is derived. In the grouting process, the electrical resistivity data is acquired in real time, an electrical resistivity distribution map at each time point is derived, and the global electrical resistivity change data in the grouting process is further acquired.

A Gauss-Newton inversion algorithm is adopted to derive electrical resistivity distribution of a subsurface formation, and an electrical resistivity distribution map at each time point is acquired through a continuous inversion process. The electrical resistivity change data is used for determining areas with the significant electrical resistivity reduction, and these areas correspond to a grout injection area and the grout diffusion range.

Step S4: for the area with highly complex geological conditions, optical fiber sensing data is acquired in real time using optical fiber sensing arranged in a grouting borehole to further acquire local strain, temperature and pressure data.

Specifically, while performing global optical fiber sensing arrangement on the tunnel face, for the area with highly complex geological conditions, after drilling the grouting borehole, the wall surface of the borehole is subjected to optical fiber arrangement. For a borehole adopting small tremie pipe grouting, optical fiber arrangement is also performed on a small tremie pipe wall surface. For a borehole with severe hole collapse and substantial water and sand inrush, dense optical fiber arrangement is performed in the borehole.

Before grouting, an optical fiber signal is calibrated based on the initial electrical resistivity distribution map.

The calibration includes two aspects:
(1) calibrating measurement parameters, including a measurement precision, a signal output precision and stability of the optical fiber signal; and
(2) performing a signal benchmark test before grouting on the optical fiber, and using the optical fiber signal generated by the formation natural environment and environmental changes as the reference to be separate from the optical fiber signal generated in the grouting process.

Step S5: data fusion analysis is performed based on the global electrical resistivity change data and the local strain, temperature and pressure data to finally acquire the grout diffusion range.

Specifically, in the grouting process, the electrical resistivity data and the optical fiber sensing data are acquired in real time. The global electrical resistivity change data of the ERT system and the local strain, temperature and pressure data of an optical fiber sensor are subjected to fusion analysis to further acquire the grout diffusion range. The specific steps are as follows:

### 1. Preprocessing

The time synchronization between the electrical resistance tomography data acquisition and the optical fiber sensor is ensured to achieve the alignment of the global electrical resistivity and the local strain, temperature and pressure data on the time axis.

The optical fiber sensing data is subjected to filtering and noise elimination, and the space resolution and time resolution of different data are resampled to ensure the space and time consistency.

2. Data Fusion after Preprocessing

The present example provides two approaches which will be respectively illustrated hereafter based on feature extraction and fusion and data analysis.

### Approach 1: Diffusion Range Prediction Based on Feature Extraction and Fusion

In a three-dimensional space, a space mapping relationship among data points is established using the space distribution of the electrode position of the ERT system and the optical fiber arrangement, and the global electrical resistivity change data and the local strain, temperature and pressure data are spliced into a multi-dimensional feature vector to be inputted into a machine learning model (for example, a decision-making tree or a SVM support vector machine) or a deep learning model (for example, a multimodal neural network) for fusion processing to obtain the diffusion range. The specific steps are as follows:

(1) First, the electrical resistivity data is preprocessed to be converted into two-dimensional or three-dimensional grid data, and a global space diffusion feature vector F Resistivity is extracted through a convolutional neural network (CNN). The data, such as the local strain, the temperature and the pressure, detected by the optical fiber is subjected to time sequence data processing, and a local time sequence feature vector F Fiber is extracted using a long short-term memory network.

(2) An attention mechanism is used for fusing the global and local feature vectors, different weights (electrical resistivity data weight w_{Resistivity}, and optical fiber data weight w_{Fiber}) are given to the global feature vector and the local feature vector, and a fused feature vector F Fusion is output.

$$\begin{matrix}{w}_{Resistivity} + {w}_{F i b e r} = 1 , \\ {F}_{F u s i o n} = {w}_{Resistivity} \cdot {F}_{Resistivity} + {w}_{F i b e r} \cdot {F}_{F i b e r} .\end{matrix}$$

(3) The fused feature vector is inputted into a fully connected layer to realize the continuous output of the grout diffusion range.

In the training process of the above learning model, constraint conditions based on a physical law are added. The electrical resistivity diffusion feature needs to conform to the diffusion equation constraint, the optical fiber strain, temperature and pressure signals need to satisfy the Hooke's law, regularization terms are added to a loss function to realize the constraint, a loss function related to the physical law is obtained. The expression by a formula is as follows:

$${L}_{p h y s i c s} = {λ}_{1} \cdot {L}_{diffusion} + {λ}_{2} \cdot {L}_{s t r ain} ;$$

wherein, λ₁ and λ₂ are physical constraint weight coefficients, and L_{diffusion} and Lₛₜᵣₐᵢₙ represent loss items of the diffusion equation and the strain constraint.

Finally, by minimizing the total loss function, the model is enabled to be able to accurately fit the data and conform to the actual physical law, so that the prediction precision and physical consistency are improved. The total loss function is as follows:

$${L}_{t o t a l} = {L}_{d a t a} ( {F}_{F u s i o n} ) + {L}_{p h y s ics} ;$$

wherein, Lₜₒₜₐₗ represents the total loss, L_{data} is loss generated by the data in the fitting process, and L_{physics} is the loss related to the physical law.

### Approach 2: Diffusion Range Construction Based on Data Analysis

An approach of combining approximate construction and refined construction is adopted, specifically:
(1) determining an area with significant electrical resistivity reduction based on preprocessed global electrical resistivity change data to acquire an approximate diffusion range in correspondence to a grout injection area and a grout diffusion range; and
(2) extracting an abnormal change point of the strain, temperature and pressure based on preprocessed local strain, temperature and pressure data, judging the precise grout front position and grout diffusion boundary in combination with a grouting theory, and refining the approximate diffusion range.

The grout diffusion range is acquired based on the electrical resistivity data. To achieve refined characterization of the grout diffusion front, the temperature and pressure abnormal change point data captured by the optical fiber sensing data is subjected to data cleaning and preprocessing, high-frequency noise is removed through a low-pass filtering algorithm, the long-time-period data is divided into a plurality of time windows or space windows for local extraction and analysis, and the electrical resistivity data and the space coordinate positions of the data point are subjected to spatial calibration so as to be in the same space coordinate. The data change rate is acquired through calculation. When the change rate exceeds a particular critical value, this point is regarded as the abnormal change point. The abnormal change point is extracted, and the abnormal change point of the optical fiber sensing path is projected onto the resistivity imaging to finally determine the precise grout front position.

To achieve refined characterization of the grout diffusion boundary, data analysis is performed on the extracted strain, temperature and pressure monitoring change data along a grouting path and the extracted abnormal change point, an area with large strain change on a strain gradient of strain data is identified, data normalization processing is performed on parameters, including surrounding rock permeability and elastic modulus along optical fiber layout acquired from preliminary geological exploration, and a weight is assigned to each data type. The weight is acquired according to repeated experiments. For example, the area with high permeability may cause greater impact on the grout diffusion, so a higher weight needs to be given to the permeability of this area. In an area with low permeability, the strain change may be more sensitive, so a higher weight may be given to this area. For a hard-rock layer, the impact of the elastic modulus is greater, so that the weight of the elastic modulus may be properly increased. For example, the optical fiber is adopted for monitoring the strain data, the surrounding rock permeability and the elastic modulus to realize the fining of the boundary. The weighting calculation formula may be as follows:

$${W}_{t o t a l} = {w}_{ϵ} \cdot {E}_{ϵ} + {w}_{K} \cdot {E}_{K} + {w}_{E} \cdot {E}_{E} ;$$

wherein, Wₜₒₜₐₗ represents a final weighted value, E_{ϵ} represents the normalized strain, E_{K} represents the permeability after the standardization, E_{E} represents the normalized elastic modulus, and w_{ϵ}, w_{K} and w_{E} respectively represent weights of the strain, the permeability, and the elastic modulus.

A physical deformation model is established:

$$Δ X = f ( ϵ , σ , K , E ) ;$$

wherein, ΔX represents a deformation magnitude of the diffusion boundary, and f(ϵ, σ, K, E) represents a deformation function of the strain, the stress, the permeability, and the elastic modulus.

The deformed boundary position is as follows:

$${X}_{n e w} = {X}_{o l d} + Δ X ;$$

wherein, X_{old} represents a position of an original diffusion boundary, and X_{new} represents the deformed boundary position.

The deformed boundary position is projected onto resistivity imaging to determine the precise grout diffusion boundary.

Step S6: determining a diffusion path at a certain time point based on the determined grout front position and grout diffusion boundary, and accumulating the diffusion path over time to acquire a final diffusion range and precisely capture the grout diffusion process.

### Example 2

The present example of the present invention provides a system for tracking grout diffusion by integrating optical fiber sensing and electrical resistance tomography, including an area module, a resistance module, an optical fiber module and a grout diffusion range analysis module.

The area module is configured to identify an area with highly complex geological conditions in the area to be grouted based on a geological exploration result of the area to be grouted.

The resistance module is configured to acquire electrical resistivity data in real time through an electrode network uniformly arranged across an entire surface of a tunnel face, and acquire global electrical resistivity change data in a grouting process using electrical resistance tomography.

The optical fiber module is configured to acquire optical fiber sensing data of the area with highly complex geological conditions in real time using optical fiber sensing arranged in a grouting borehole to further acquire local strain, temperature and pressure data.

The grout diffusion range analysis module is configured to perform data fusion and calculation analysis on the global electrical resistivity change data and the local strain, temperature and pressure data, acquire a change rate of data through calculation, define a point as an abnormal change point when the change rate exceeds a predefined critical value, extract the abnormal change point, and project the abnormal change point on an optical fiber sensing path onto resistivity imaging to determine a grout front position; and acquire a deformation magnitude of a grout diffusion boundary through calculation, and project the deformed boundary position onto resistivity imaging to determine a grout diffusion boundary.

A grout diffusion range is determined according to the resistivity imaging with the determined grout front position and grout diffusion boundary to capture a grout diffusion process.

### Example 3

The present example of the present invention provides a computer program product, including a computer program. The computer program, when executed by a processor, implements the method for tracking grout diffusion by integrating optical fiber sensing and electrical resistance tomography.

### Example 4

The present example of the present invention provides a non-transitory computer-readable storage medium configured to store a computer instruction. The computer instruction, when executed by a processor, implements the method for tracking grout diffusion by integrating optical fiber sensing and electrical resistance tomography.

### Example 5

The present example of the present invention provides an electronic device including a processor, a memory and a computer program. The processor is connected to the memory, the computer program is stored in the memory, and when the electronic device operates, the processor executes the computer program stored in the memory, so as to cause the electronic device to implement the method for tracking grout diffusion by integrating optical fiber sensing and electrical resistance tomography.

The present invention is described with reference to the flowcharts and/or block diagrams of the method, the device (system), and the computer program product according to the embodiments of the present invention. It should be understood that computer program instructions can realize each procedure and/or block in the flowcharts and/or block diagrams and a combination of procedures and/or blocks in the flowcharts and/or block diagrams. These computer program instructions can be provided to a general-purpose computer, a special-purpose computer, an embedded processor or other programmable data processing devices to generate a machine, so that the instructions executed by the processor of a computer or other programmable data processing device generates a device to achieve the functions specified in one or more procedures in a flowchart and/or one or more blocks in a block diagram.

These computer program instructions can also be loaded onto a computer or other programmable data processing devices so that a series of operation steps may be executed on the computer or other programmable devices to generate computer-implemented processing. Therefore, the instructions executed on the computer or other programmable devices provide the steps to achieve the functions specified in one or more procedures in a flowchart and/or one or more blocks in a block diagram.

Although the specific implementation of the present invention has been described in combination with the accompanying drawings, it is not intended to limit the protection scope of the present invention. Those skilled in the art shall understand that various modifications or variations made by those skilled in the art without creative efforts based on the technical solutions of the present invention shall be within the protection scope of the present invention.

1. A method for tracking grout diffusion by integrating optical fiber sensing and electrical resistance tomography, comprising:
conducting geological exploration of an area to be grouted;
identifying an area with highly complex geological conditions in the area to be grouted based on a geological exploration result of the area to be grouted;
acquiring electrical resistivity data in real time through an electrode network uniformly arranged across an entire surface of a tunnel face, and acquiring global electrical resistivity change data in a grouting process using electrical resistance tomography;
acquiring, for the area with highly complex geological conditions, optical fiber sensing data in real time using optical fiber sensing arranged in a grouting borehole to further acquire local strain, temperature and pressure data;
performing data fusion and calculation analysis on the acquired global electrical resistivity change data and the local strain, temperature and pressure data, acquiring a change rate of data through calculation, defining a point as an abnormal change point when the change rate exceeds a predefined critical value, extracting the abnormal change point, and projecting the abnormal change point on an optical fiber sensing path onto resistivity imaging to determine a grout front position; acquiring a deformation magnitude of a grout diffusion boundary through calculation, and projecting the deformed boundary position onto resistivity imaging to determine a grout diffusion boundary; and
determining a grout diffusion range according to the resistivity imaging with the determined grout front position and grout diffusion boundary to capture a grout diffusion process, wherein the data fusion analysis constructs the grout diffusion range based on a data analysis approach, specifically:
determining an area with significant electrical resistivity reduction based on preprocessed global electrical resistivity change data to acquire an approximate diffusion range in correspondence to a grout injection area and a grout diffusion range;
extracting an abnormal change point of the strain, temperature and pressure based on preprocessed local strain, temperature and pressure data, judging the precise grout front position and grout diffusion boundary in combination with a grouting theory, and refining the approximate diffusion range;
performing data analysis on the extracted strain, temperature and pressure monitoring change data along a grouting path and the extracted abnormal change point, identifying an area with large strain change on a strain gradient of strain data, performing data normalization processing on parameters, comprising surrounding rock permeability and elastic modulus along optical fiber layout acquired from preliminary geological exploration, and assigning a weight to each data type according to a weighted calculation formula:
$${W}_{t o t a l} = {w}_{ϵ} \cdot {E}_{ϵ} + {w}_{K} \cdot {E}_{K} + {w}_{E} \cdot {E}_{E} ;$$
wherein, Wₜₒₜₐₗ representing a final weighted value, E_{ϵ} representing the normalized strain, E_{K} representing the normalized permeability, E_{E} representing the normalized elastic modulus, and w_{ϵ}, w_{K}, and w_{E} respectively representing weights of the strain, the permeability and the elastic modulus;
establishing a physical deformation model:
$$Δ X = f ( ϵ , σ , K , E ) ;$$
wherein, ΔX representing a deformation magnitude of the diffusion boundary, and f(ϵ, σ, K, E) representing a deformation function of the strain, the stress, the permeability, and the elastic modulus;
determining the deformed boundary position:
$${X}_{n e w} = {X}_{o l d} + Δ X ;$$
wherein, X_{old} representing a position of an original diffusion boundary, and X_{new} representing the deformed boundary position;
projecting the deformed boundary position onto resistivity imaging to determine the precise grout diffusion boundary; and
determining a diffusion path at a certain time point based on the determined grout front position and grout diffusion boundary, and accumulating the diffusion path over time to acquire a final diffusion range and precisely capture the grout diffusion process.

2. The method for tracking grout diffusion by integrating optical fiber sensing and electrical resistance tomography according to claim 1, wherein the area with highly complex geological conditions is obtained by labeling formation complexity according to subsurface structure and formation feature data obtained in the geological exploring result to divide areas with different geological conditions into areas with highly complex geological conditions and areas with lowly complex geological conditions; and
the area with highly complex geological conditions is defined to comprise but not limited to an area of a fissure zone, a fracture zone, a water-rich formation, a tight formation, a weak formation, and a heterogeneous rock formation.

3. The method for tracking grout diffusion by integrating optical fiber sensing and electrical resistance tomography according to claim 1, wherein according to the electrical resistance tomography, a Gauss-Newton inversion algorithm is adopted to derive electrical resistivity distribution of a subsurface formation based on the electrical resistivity data, an electrical resistivity distribution map at each time point is acquired through a continuous inversion process, and the global electrical resistivity change data in the grouting process is further acquired.

4. The method for tracking grout diffusion by integrating optical fiber sensing and electrical resistance tomography according to claim 1, wherein the arrangement of optical fiber sensing in the grouting borehole comprises:
arranging optical fiber on a borehole wall surface after drilling the grouting borehole;
arranging optical fiber on a small tremie pipe wall surface for a borehole adopting small tremie pipe grouting; and
arranging dense optical fiber in a borehole with severe hole collapse and substantial water and sand inrush.

5. The method for tracking grout diffusion by integrating optical fiber sensing and electrical resistance tomography according to claim 1, wherein the data fusion and calculation analysis comprises:
preprocessing the global electrical resistivity change data and the local strain, temperature and pressure data for spatiotemporal alignment;
separately performing feature extraction on the preprocessed global electrical resistivity change data and local strain, temperature and pressure data;
fusing the extracted features; and
determining the grout diffusion range based on the fused features.

6. A computer program product, comprising a computer program, wherein the computer program, when executed by a processor, implements the method for tracking grout diffusion by integrating optical fiber sensing and electrical resistance tomography according to claim 1.

7. A non-transitory computer-readable storage medium, configured to store a computer instruction, wherein the computer instruction, when executed by a processor, implements the method for tracking grout diffusion by integrating optical fiber sensing and electrical resistance tomography according to claim 1.

8. An electronic device, comprising a processor, a memory and a computer program, wherein the processor is connected to the memory, the computer program is stored in the memory, and when the electronic device operates, the processor executes the computer program stored in the memory, so as to cause the electronic device to implement the method for tracking grout diffusion by integrating optical fiber sensing and electrical resistance tomography according to claim 1.
